(19) United States
(12) Patent Application Publication
(10) Pub. No.: US 2007/0086440 A1
(43) Pub. Date: Apr. 19, 2007

(54) Data transmission method and system

(75) Inventor: Futao Xiao, Shenzhen (CN)

Correspondence Address: MCDERMOTT WILL & EMERY LLP, 600 13TH STREET, N.W., WASHINGTON, DC, 20005-3096, US

(73) Assignee: HUAWEI TECHNOLOGIES CO., LTD.

(21) Appl. No.: 11/545,455

(22) Filed: Oct. 11, 2006

(30) Foreign Application Priority Data
Oct. 14, 2005 (CN) 200510100405.3

(51) Int. Cl. H04L 12/66

(52) U.S. Cl. 370/352; 370/401

(57) ABSTRACT

A data transmission system and method, including the steps of: a calling media gateway receiving message packets transmitted by a calling ISDN terminal through a plurality of calling circuits, and converting the message packets into data packets suitable for being transmitted through a single IP bearer link; the calling media gateway transmitting the data packets to a called media gateway through one IP bearer link; and the called media gateway parsing the data packets, and transmitting the parsed data packets to a called ISDN terminal through a plurality of called circuits. In the present invention, there is only one IP link between the two media gateways, and the delay is fixed when data of a plurality of links are passed across an IP network, therefore it is possible for the an multi-link ISDN call to avoid a data asynchrony due to inconsistencies of a plurality of IP link routes.

### FIELD OF THE INVENTION

The present invention relates to the data communication field, and particularly to a method and system for data transmission through an IP network in the Next Generation Network.

### BACKGROUND OF THE INVENTION

The NGN (Next Generation Network) is a public telecommunication network built based on IP technologies, and can accommodate various forms of information. It can implement transmission and management of audio, video and data signals over a platform under a uniform administration and provide various wideband applications and conventional telecommunications services. Thus, it is an integrated-service network that indeed implements an integration of wideband and narrowband, an integration of wired and wireless, an integration of active and passive and an integration of transmission and access.

The NGN supports the access to and the applications of the ISDN (Integrated Services Digital Network). As shown in FIG. 1, there are is a plurality of telephone numbers between ISDN terminals, and each telephone number corresponds to one or two 64K circuits, with an implementation of a video communication at various rates and with a bandwidth of 128k to 2M or above. The ISDN terminals have an access to media gateways connected through an IP network. An IP connection is established for each circuit under the control of a soft switch, and data packets of each calling circuit are transmitted transparently to a corresponding called circuit through a corresponding IP connection. A format of the data packets is an H.221 message packet. Details related to the H.221 protocol can be found in the LC-Text: Recommendation H.221 “Frame Structure for a 64 to 1920 Kbit/s Channel in Audiovisual Teleservices”, which is incorporated herein by reference and therefore descriptions thereof are omitted.

### SUMMARY OF THE INVENTION

An embodiment of the present invention provides a data transmission method for transmitting data through an IP bearer link between a calling media gateway and a called media gateway, wherein the method comprises the steps of:

A. the calling media gateway receiving message packets transmitted by a calling ISDN terminal through a plurality of calling circuits, and converting the message packets into data packets suitable for being transmitted through a single IP bearer link;

B. the calling media gateway transmitting the data packets to the called media gateway through one IP bearer link; and

C. the called media gateway parsing the data packets, and transmitting the parsed data packets to a called ISDN terminal through a plurality of called circuits.

Optionally in step A, the conversion of the messages packets comprises parsing the message packets to obtain audio and video streams;

in step B, the calling media gateway transmitting the audio and video streams to the called media gateway through one IP bearer link; and

in step C, the called media gateway re-encapsulating the audio and video streams into message packets in the same format as the message packets transmitted by the calling ISDN terminal, and transmitting the re-encapsulated message packets to the called ISDN terminal through the plurality of called circuits.

Optionally in step A, the conversion of the messages packets comprises adding circuit tags indicative of a calling circuit to which each message packet belongs to the message packets from the different calling circuits;

in step B, the calling media gateway transmitting the message packets with the circuit tags to the called media gateway through one IP bearer link; and

in step C, the called media gateway parsing the message packets, and transmitting the message packets to the called ISDN terminal through the plurality of called circuits corresponding to the respective calling circuits according to the circuit tags in the message packets.

Optionally the IP bearer link further comprises a backup IP bearer link; and

the calling media gateway checks a status of the present IP bearer link periodically, and transmits the message packets to the called media gateway through the backup IP bearer link when the present IP bearer link is found unavailable.

Optionally the format of the message packets is a H.221 format.

Another embodiment of the present invention provides a data transmission system comprising a calling media gateway and a called media gateway with data transmitted therebetween through an IP bearer link, wherein:

the calling media gateway is adapted to:

receive message packets transmitted by a calling ISDN terminal through a plurality of calling circuits, convert the message packets into data packets suitable for being transmitted through a single IP bearer link, and transmit the message packets to the called media gateway through one IP bearer link; and

the called media gateway is adapted to:

parse the data packets, and transmit the parsed data packets to a called ISDN terminal through a plurality of called circuits.

Optionally for the conversion of the messages packets, the calling media gateway is adapted to parse the message packets to obtain audio and video streams, and transmit the audio and video streams to the called media gateway through one IP bearer link; and

the called media gateway is adapted to re-encapsulate the audio and video streams into message packets in the same format as the message packets transmitted by the calling ISDN terminal, and transmit the re-encapsulated message packets to the called ISDN terminal through the plurality of called circuits.

Optionally for the conversion of the messages packets, the calling media gateway is adapted to add circuit tags indicative of a calling circuit to which each message packet belongs to the message packets from the different calling circuits, and transmit the message packets with the circuit tags to the called media gateway through one IP bearer link; and

the called media gateway is adapted to parse the message packets, and transmit the message packets to the called ISDN terminal through the plurality of called circuits corresponding to the respective calling circuits according to the circuit tags in the message packets.

Optionally the IP bearer link further comprises a backup IP bearer link; and

the calling media gateway checks a status of the present IP bearer link periodically, and transmits the message packets to the called media gateway through the backup IP bearer link when the present IP bearer link is found unavailable.

Optionally the format of the message packets is a H.221 format.

A further embodiment of the present invention provides a media gateway for transmitting data through an IP bearer link to anther media gateway, wherein comprising:

receiving means adapted to receive message packets transmitted by a calling ISDN terminal through a plurality of calling circuits;

converting means adapted to convert the message packets into data packets suitable for being transmitted through a single IP bearer link; and

transmitting means adapted to transmit the message packets to another media gateway through one IP bearer link.

Optionally for the conversion of the messages packets, the converting means is adapted to parse the message packets to obtain audio and video streams; and

the transmitting means is adapted to transmit the audio and video streams to another media gateway through one IP bearer link; and

Optionally for the conversion of the messages packets, the converting means is adapted to add circuit tags indicative of a calling circuit to which each message packet belongs to the message packets from the different calling circuits; and

the transmitting means is adapted to transmit the message packets with the circuit tags to another media gateway through one IP bearer link.

Optionally the media gateway is further adapted to receive data through an IP bearer link from another media gateway, and further comprises:

parsing means adapted to parse data packets received through one IP bearer link; and

transmitting means adapted to transmit the parsed data packets to a called ISDN terminal through a plurality of called circuits.

A further embodiment of the present invention provides a media gateway for receiving data through an IP bearer link from anther media gateway, wherein comprising:

parsing means adapted to parse data packets received through one IP bearer link; and

transmitting means adapted to transmit the parsed data packets to a called ISDN terminal through a plurality of called circuits.

Optionally in the case that the data packets comprise audio and video streams, the parsing means is adapted to re-encapsulate the audio and video streams into message packets in a format for a called ISDN terminal; and

the transmitting means is adapted to transmit the re-encapsulated message packets to the called ISDN terminal through a plurality of called circuits.

Optionally in the case that the data packets comprise message packets with circuit tags, the parsing means is adapted to parse the message packets to obtain the circuit tags; and

the transmitting means is adapted to transmit the message packets to a called ISDN terminal through a plurality of called circuits corresponding to the circuit tags.

According to the embodiments of the present invention, there is only one IP between the two media gateway, and the delay is fixed when data of a plurality of links are passed across an IP network, and therefore it is possible for a multi-link ISDN call to avoid a data asynchrony due to inconsistencies of a plurality of IP link routes.

### BRIEF DESCRIPTIONS OF THE DRAWINGS

FIG. 1 is an implementation principle diagram of transmitting data through an IP network in the prior art; and

FIG. 2 is an implementation principle diagram of transmitting data through an IP network according to an embodiment of the present invention.

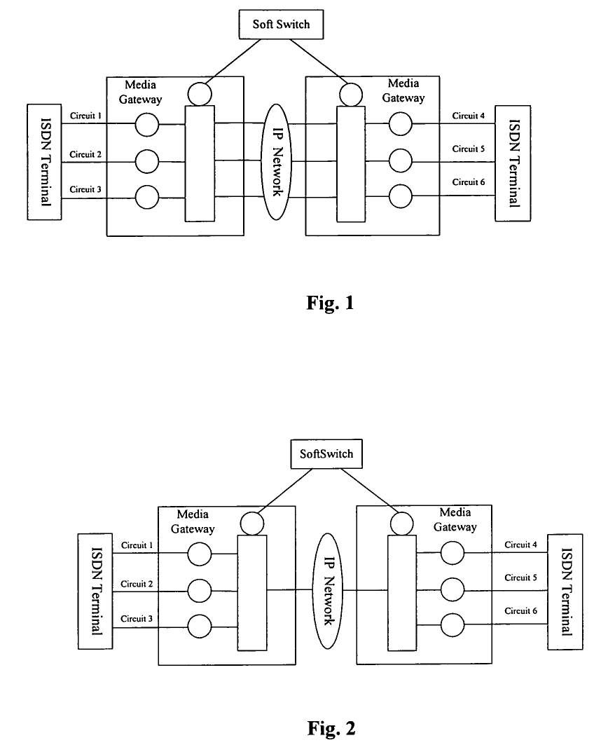

### DETAILED DESCRIPTIONS OF THE EMBODIMENTS

Hereinafter, objects, aspects and advantages of the present invention will become more apparent from the following descriptions of preferred embodiments of the present invention with reference to the drawings. However, it shall be appreciated that the embodiments described here are merely illustrations of the present invention without any restriction to the present invention.

According to an embodiment of the present invention, there may be only one IP link used to transmit data between a calling media gateway transmits data and a called media gateway regardless of whatever bandwidth used for a calling ISDN terminal to make a call. Thus, it is possible to avoid a data aggregation failure of a called ISDN terminal and hence an effect on a normal communication due to inconsistent IP routes in the case of a plurality of IP links used for data transmission.

As shown in FIG. 2, according to an embodiment of the present invention, a calling media gateway receives H.221 message packets transmitted by a calling ISDN terminal through a plurality of circuits, and then terminates an H.221 protocol process. It parses the H.221 message packets transmitted from the respective circuits, obtains audio and video streams from the packets through searches for frame heads, and in turn transmits the streams to a called media gateway through a single IP link. Upon receipt of the audio and video streams transmitted by the calling media gateway, the called media gateway re-encapsulates them into H.221 frames and transmits re-encapsulated H.221 message packets to the called ISDN terminal though a plurality of circuits.

According to another embodiment of the present invention, the calling media gateway doesn't parse the H.221 message packets transmitted by the calling ISDN terminal through the plurality of circuits, and instead, adds respective circuit tags to the H.221 message packets received from the different circuits. Particularly, a tag indicates a calling circuit to which each message packet belongs, for example, an H.221 message packet received from a circuit 1 is provided with a circuit tag 1 at the front, an H.221 message packet received from a circuit 2 is provided with a circuit tag 2 at the front, etc. Then, the calling media gateway transmits the circuit-tagged H.221 message packets to the called media gateway through one IP link. Upon receipt of the H.221 message packets transmitted from the calling media gateway, the called media gateway analyzes the circuit tags in the message packets, and sends the message packets to one of the called circuits corresponding to the respective circuit tags. For example, the message packets with the tag 1 are transmitted to the called ISDN terminal through a link 4. According to the embodiment, the media gateway requires no processing of any specific protocol and merely functions as a relay, which can reduce the complexity of the media gateway.

For an increase in the data transmission reliability, a backup IP link can be provided for each call between the media gateways according to an embodiment of the present invention. The calling media gateway checks a status of the primary IP link periodically, and may transmit the packets to the called media gateway through the backup IP link when the primary IP bearer link is found unavailable.

According to the embodiments of the present invention, only one IP link is used to transmit data between the calling media gateway and the called media gateway, and therefore the delay is fixed when the data transmitted from the plurality of links are passed across the IP network, and it is possible to avoid a data asynchrony due to inconsistencies of a plurality of IP link routes.

Although the present invention has been described in connection with the preferred embodiments thereof, it shall be appreciated that the present invention is not limited to the embodiments and that various equivalent changes can be made thereto with reference to the description and the drawings without a departure from the scope of the present invention as defined by the accompanied claims.

What is claimed is:

1. A data transmission method for transmitting data through an IP bearer link between a calling media gateway and a called media gateway, wherein the method comprises the steps of:
A. the calling media gateway receiving message packets transmitted by a calling ISDN terminal through a plurality of calling circuits, and converting the message packets into data packets suitable for being transmitted through a single IP bearer link;
B. the calling media gateway transmitting the data packets to the called media gateway through one IP bearer link; and
C. the called media gateway parsing the data packets, and transmitting the parsed data packets to a called ISDN terminal through a plurality of called circuits.

2. The data transmission method according to claim 1, wherein:
in step A, the conversion of the messages packets comprises parsing the message packets to obtain audio and video streams;
in step B, the calling media gateway transmitting the audio and video streams to the called media gateway through one IP bearer link; and
in step C, the called media gateway re-encapsulating the audio and video streams into message packets in the same format as the message packets transmitted by the calling ISDN terminal, and transmitting the re-encapsulated message packets to the called ISDN terminal through the plurality of called circuits.

3. The data transmission method according to claim 1, wherein:
in step A, the conversion of the messages packets comprises adding circuit tags indicative of a calling circuit to which each message packet belongs to the message packets from the different calling circuits;
in step B, the calling media gateway transmitting the message packets with the circuit tags to the called media gateway through one IP bearer link; and
in step C, the called media gateway parsing the message packets, and transmitting the message packets to the called ISDN terminal through the plurality of called circuits corresponding to the respective calling circuits according to the circuit tags in the message packets.

4. The data transmission method according to claim 1, wherein the IP bearer link further comprises a backup IP bearer link; and
the calling media gateway checks a status of the present IP bearer link periodically, and transmits the message packets to the called media gateway through the backup IP bearer link when the present IP bearer link is found unavailable.

5. The data transmission method according to claim 2, wherein the IP bearer link further comprises a backup IP bearer link; and
the calling media gateway checks a status of the present IP bearer link periodically, and transmits the message packets to the called media gateway through the backup IP bearer link when the present IP bearer link is found unavailable.

6. The data transmission method according to claim 3, wherein the IP bearer link further comprises a backup IP bearer link; and
the calling media gateway checks a status of the present IP bearer link periodically, and transmits the message packets to the called media gateway through the backup IP bearer link when the present IP bearer link is found unavailable.

7. The data transmission method according to claim 1, wherein the format of the message packets is a H.221 format.

8. The data transmission method according to claim 2, wherein the format of the message packets is a H.221 format.

9. The data transmission method according to claim 3, wherein the format of the message packets is a H.221 format.

10. A data transmission system comprising a calling media gateway and a called media gateway with data transmitted therebetween through an IP bearer link, wherein:
the calling media gateway is adapted to:
receive message packets transmitted by a calling ISDN terminal through a plurality of calling circuits, convert the message packets into data packets suitable for being transmitted through a single IP bearer link, and transmit the message packets to the called media gateway through one IP bearer link; and
the called media gateway is adapted to:
parse the data packets, and transmit the parsed data packets to a called ISDN terminal through a plurality of called circuits.

11. The data transmission system according to claim 10, wherein for the conversion of the messages packets, the calling media gateway is adapted to parse the message packets to obtain audio and video streams, and transmit the audio and video streams to the called media gateway through one IP bearer link; and
the called media gateway is adapted to re-encapsulate the audio and video streams into message packets in the same format as the message packets transmitted by the calling ISDN terminal, and transmit the re-encapsulated message packets to the called ISDN terminal through the plurality of called circuits.

12. The data transmission system according to claim 10, wherein for the conversion of the messages packets, the calling media gateway is adapted to add circuit tags indicative of a calling circuit to which each message packet belongs to the message packets from the different calling circuits, and transmit the message packets with the circuit tags to the called media gateway through one IP bearer link; and
the called media gateway is adapted to parse the message packets, and transmit the message packets to the called ISDN terminal through the plurality of called circuits corresponding to the respective calling circuits according to the circuit tags in the message packets.

13. The data transmission system according to claim 10, wherein the IP bearer link further comprises a backup IP bearer link; and
the calling media gateway checks a status of the present IP bearer link periodically, and transmits the message packets to the called media gateway through the backup IP bearer link when the present IP bearer link is found unavailable.

14. The data transmission system according to claim 11, wherein the IP bearer link further comprises a backup IP bearer link; and
the calling media gateway checks a status of the present IP bearer link periodically, and transmits the message packets to the called media gateway through the backup IP bearer link when the present IP bearer link is found unavailable.

15. The data transmission system according to claim 12, wherein the IP bearer link further comprises a backup IP bearer link; and
the calling media gateway checks a status of the present IP bearer link periodically, and transmits the message packets to the called media gateway through the backup IP bearer link when the present IP bearer link is found unavailable.

16. The data transmission system according to claim 10, wherein the format of the message packets is a H.221 format.

17. The data transmission system according to claim 11, wherein the format of the message packets is a H.221 format.

18. The data transmission system according to claim 12, wherein the format of the message packets is a H.221 format.

19. A media gateway for transmitting data through an IP bearer link to anther media gateway, wherein comprising:
receiving means adapted to receive message packets transmitted by a calling ISDN terminal through a plurality of calling circuits;
converting means adapted to convert the message packets into data packets suitable for being transmitted through a single IP bearer link; and
transmitting means adapted to transmit the message packets to another media gateway through one IP bearer link.

20. The media gateway according to claim 19, wherein for the conversion of the messages packets, the converting means is adapted to parse the message packets to obtain audio and video streams; and
the transmitting means is adapted to transmit the audio and video streams to another media gateway through one IP bearer link; and

21. The media gateway according to according to claim 19, wherein for the conversion of the messages packets, the converting means is adapted to add circuit tags indicative of a calling circuit to which each message packet belongs to the message packets from the different calling circuits; and
the transmitting means is adapted to transmit the message packets with the circuit tags to another media gateway through one IP bearer link.

22. The media gateway according to claim 19, wherein the media gateway is further adapted to receive data through an IP bearer link from another media gateway, and further comprises:
parsing means adapted to parse data packets received through one IP bearer link; and
transmitting means adapted to transmit the parsed data packets to a called ISDN terminal through a plurality of called circuits.

23. A media gateway for receiving data through an IP bearer link from anther media gateway, wherein comprising:
parsing means adapted to parse data packets received through one IP bearer link; and
transmitting means adapted to transmit the parsed data packets to a called ISDN terminal through a plurality of called circuits.

24. The media gateway according to claim 23, wherein in the case that the data packets comprise audio and video streams, the parsing means is adapted to re-encapsulate the audio and video streams into message packets in a format for a called ISDN terminal; and
the transmitting means is adapted to transmit the re-encapsulated message packets to the called ISDN terminal through a plurality of called circuits.

25. The media gateway according to claim 23, wherein in the case that the data packets comprise message packets with circuit tags, the parsing means is adapted to parse the message packets to obtain the circuit tags; and
the transmitting means is adapted to transmit the message packets to a called ISDN terminal through a plurality of called circuits corresponding to the circuit tags.
